(19) United States
(12) Patent Application Publication
(10) Pub. No.: US 2012/0079082 A1
(43) Pub. Date: Mar. 29, 2012

(54) User Data Convergence Network System and Method for Subscription to Notification

(75) Inventors: Zhaoming Ding, Guangdong Province (CN); Kun Zhu, Shenzhen (CN); Aiyan Qu, Shenzhen (CN)

(73) Assignee: ZTE CORPORATION, Shenzhen City, Guangdong Province (CN)

(21) Appl. No.: 13/258,318

(22) PCT Filed: Oct. 28, 2009
(86) PCT No.: PCT/CN2009/074643

§ 371 Date: Sep. 21, 2011

(30) Foreign Application Priority Data
Jun. 11, 2009 (CN) 200910142473.4

(51) Int. Cl. G06F 15/173; G06F 15/177

(52) U.S. Cl. 709/220; 709/224

(57) ABSTRACT

A method for implementing subscription to notification is disclosed in the present invention, which is applied in a user data convergence network including a user data repository. The method comprises: establishing a subscription to notification relationship in the user data repository; said subscription to notification relationship comprises notification triggering condition that describes the condition of the user data repository sending a notification message; when receiving an update data request, if the update data request meets the notification triggering condition, the user data repository sends a notification message to notification event subscriber. Compared with the prior technology, the present invention effectively solves the problem about how to implement subscription to notification in a network system in which the application logic processing and data storage are separated, and implements the triggering of the expected notification message based on the established subscription to notification relationship.

### TECHNICAL FIELD

The present invention relates to the field of mobile communication, and more especially, to a user data convergence (UDC) network system and method for implementing subscription to notification based on the UDC network.

### BACKGROUND OF THE RELATED TECHNOLOGY

With the development of Internet Technology (IT) software and hardware technologies as well as the development of services, besides the conventional public switched telephone network (PSTN) as well as the 2^{nd} generation network, more and more communication networks are introduced and become standards, such as the 3^{rd} generation (3G) network, IP multimedia sub-system (IMS) network, worldwide interoperability for microwave access (WiMAX) network, soft switching network and so on, which significantly increases the user data in the network.

With the explosion of user data in the network, the original user data storage and the method for provision are more and more difficult to adapt to the rapid development of networks. The data decentralized management results in high operating expenditure (OPEX), and garbage data is hard to be deleted, and it is difficult to guarantee the data consistency and the data security, and there is no effective means for data mining analysis. Moreover, since the data storage network element has different external interfaces, the data access interface is complicated, and the interface and services are tightly coupled with each other, and the data cannot be transported transparently, and new services are difficult to be developed effectively, and issues in the user data management are increasingly evident.

Therefore, the concept of uniform user data model is provided in the industry, that is, the data scattering in different network elements but belonging to the same user are converged, and take the user identity as the basic identity, and it is organized according to the uniform data structure and works as the unique user data source in all networks.

In physical implementation, the uniform user data model is stored in the unique data storage network element of the network: the center database (CDB), and the CDB stores the uniform data model of the user to guarantee the consistency, reliability and security of the data, and it provides an open interface unrelated to the services and data and provides data access service for other data query network elements.

When converging terminal data, data in the access or core network, service data and Internet service data, applications and data are decoupled and a uniform user data center is uniformly managed and established, therefore, the network can be simplified, new service publication time can be shortened, and service innovation is promoted, thus to lay a foundation for providing the operators with competitive service convergence.

FIG. 1 describes the network system model established for the UDC by the 3^{rd} generation partnership project (3GPP) organization in the prior technology. Wherein, the UDC network comprises application front ends supporting a plurality of applications and a user data repository. The application front end process the application logic that is not related to the data and is not responsible for storing the user data information. As the user data center in the network, the user data repository converges all kinds of application data and provides a uniform open Ud access interface for different application front ends.

The UDC network system does not affect the existing network system, that is, the existing interfaces between the application front ends and the core network elements, the service layer applications as well as the business & operation support system (BOSS) will not be affected. For example, the application front end supporting the home subscriber service (HSS) application needs to support the S6a/S6d interface, Cx, Sh interface and so on based on Diameter protocol and supported by HSS. The application end supporting the home location register (HLR) application needs to support the C, D and Gr interfaces and so on based on the mobile application part (MAP) protocol and supported by the HLR.

The UDC network is required to support the subscription to notification function, the subscription to notification mechanism in the original network, however, is based on network systems in which applications and data are coupled, that is, the application logic processing and data are stored in one network entity, thus it cannot meet effectively the requirement of network systems in which the service applications and data are separated.

The application server (AS) might send a subscription to notification message to the HSS application front end via the existing Sh interface to request subscribing the notification event about the change of a specific user's subscription data stored in the user data repository. However, there is no technical scheme for the HSS application front end to establish the subscription to notification relationship in the user data repository based on the Ud interface in the prior technology.

Furthermore, for a certain non-obvious subscription to notification, for example, due to the management requirements, the operators need to delete the location information of a registered user stored in the home network, and at this time, the home network should trigger the location cancellation message to the network element entity registered by the user. However, there is no technical scheme to establish the implicit subscription to notification relationship and to trigger the location cancellation message based on the UDC network system in the prior technology.

In addition, the HSS supporting the Diameter application is required to send the location cancellation message to other networks based on the MAP application in the prior technology. For example, users switch to the mobile management entity (MME) in the Evolved Packet System (EPS) network from the Serving GPRS Supporting Node (SGSN) entity in the General Packet Radio System (GPRS) which does not support the Idle-mode Signalling Reduce (ISR) function, and the MME needs to set the single registration indication flag bit. After the HSS application front end receives the update location request message sent from the MME, it checks the single registration indication flag bit, and it needs to send the location cancellation message based on the MAP protocol to the SGSN entity which the user has already registered. In the prior technology, however, there is no technical scheme for implementing the message triggering between different network domains based on the UDC network system.

To sum up, it needs the corresponding technical schemes to solve the problems about how to establish an explicit subscription to notification relationship, that is, establish a subscription to notification relationship with a request message and an implicit subscription to notification relationship, that is, pre-configure a subscription to notification relationship in advance based on the UDC network system as well as how to implement the triggering of the expected notification message based on this subscription to notification relationship.

Because of this, it is desirable to provide a subscription to notification technology based on the UDC network to implement the subscription to notification in the UDC network system.

### SUMMARY OF THE INVENTION

To solve the problem in the prior technology, the present invention provides a UDC network system as well as a method for implementing subscription to notification based on the UDC network to solve the problem about how to implement subscription to notification in the UDC network system.

The present invention provides a method for implementing subscription to notification, and the method is applied to a user data convergence (UDC) network including a user data repository, and the method comprises:
establishing a subscription to notification relationship in said user data repository; said subscription to notification relationship comprising a notification triggering condition which describes a condition for the user data repository sending a notification message;
when receiving an update data request, if said update data request meets the notification triggering condition or a notification is required to be sent, said user data repository sending the notification message to a notification event subscriber.

Preferably, a following method is used to establish said subscription to notification relationship in said user data repository:
after said user data repository receives a subscription to notification request message or a modify data request message carrying a subscription to notification request indicator, store the subscription to notification information; alternatively
said user data repository pre-configures and stores said subscription to notification information according to the local configuration policy.

Preferably, said subscription to notification request message or modify data request message is sent by an application server (AS) supporting the UDC to the user data repository via an AS application front end, or sent by a home subscriber service application front end indicated by the AS which doesn't support the UDC to the user data repository.

Preferably, said step of establishing the subscription to notification relationship comprises: storing an original address of subscriber and subscription data, and setting a data subscription status corresponding to said notification triggering condition as subscribed;
wherein said original address of subscriber comprises: the AS identity or address, or the AS application front end identity or address;
the subscription data describes that user subscription data corresponding to subscription data subscribed by subscription to notification event is a request data identity or a request data domain name.

Alternatively,
the step of establishing the subscription to notification relationship comprises: the user data repository pre-configures and stores the notification triggering condition and notification type according to the local configuration policy, and the notification triggering condition has a corresponding relationship with the notification type. Preferably, content of said notification triggering condition comprises the data subscription status and a data change status, or a subscription event, or the subscription event as well as the data change status;
said data subscription status describes a subscription status of data requested by a subscription to notification event on subscription data;
said data change status describes a change status of data subscribed by the subscription to notification event on the subscription data;
said subscription event describes an event to be triggered for the notification message.

As long as any one of following conditions is met, the update data request meets the notification triggering condition:
the data is in the subscribed status and has changed;
the event is in the subscribed status;
the event is in the subscribed status and data related to the event changes;
a message corresponding to the event carries a notification flag indicating to send said notification message.

Preferably, after the step of receiving said update data request, said method also comprises:
judging whether the user subscription data changes or not and checking whether the user subscription data is in the subscribed status or not, or judging whether an event corresponding to the update data request is in the subscribed status, or judging whether the event corresponding to the update data request is in the subscribed status and the related user subscription data changes or not, or judging whether the event corresponding to said update data request carries the notification flag or not; and
determining whether the update data request meets said notification triggering condition or not according to a judgment result.

Preferably, the step of judging whether the user subscription data changes or not comprises:
the user data repository or an application front end compares whether the user subscription data changes or not and acquires a comparison result;
the step of determining whether the update data request meets the notification triggering condition or not according to the judgment result comprises: said user data repository determining whether the update data request meets the notification triggering condition or not according to the comparison result.

Preferably, after the step of receiving said update data request, said method also comprises:
judging whether a notification is required to be sent or not according to related information of the application front end, which comprises: the user data repository judging whether the application front end sending the request message supports an application type required to process the notification message;
alternatively
judging whether to send a notification or not according to an indication flag carried in the request message. Preferably, said subscription to notification relationship comprises the notification type, and said notification type is used to indicate the service operation required to be executed by the notification event subscriber; said notification message carries said notification type and notification data information.

Preferably, when said notification type indicates the notification event subscriber to perform the subscription to notification on the subscription data, said notification data information comprises the original address of subscriber, a user identity and subscription to notification data said subscription to notification data is the latest changing content of the data subscribed in the subscription to notification event;
when said notification type indicates the notification event subscriber to execute location cancellation, said notification data information comprises the user identity as well as a current registered network entity identity or address of user.

Preferably, the step of said notification type indicating the notification event subscriber to perform the location cancellation comprises:
indicating the HSS application front end to delete the user's registration information in a current network, or indicating a home location register (HLR) application front end to delete the user's registration information in a current general packet radio system (GPRS) network.

In order to solve the abovementioned technical problem, the present invention also provides a user data convergence (UDC) network system, which comprises a first application server (AS), a second application server, a home subscriber service (HSS) application front end and a user data repository, wherein:
said first application server is configured to send a subscription to notification request message to the HSS application front end;
said HSS application front end is configured to: after receiving said subscription to notification request message sent from said first AS, send the subscription to notification request message or a modify data request message carrying a subscription to notification request indicator to the user data repository;
said second AS is configured to send the subscription to notification request message or the modify data request message carrying the subscription to notification request indicator to the user data repository via an AS application front end;
said user data repository is configured to: establish a subscription to notification relationship according to the subscription to notification request message or the modify data request message carrying the subscription to notification request indicator, or pre-establish said subscription to notification relationship; said subscription to notification relationship comprises a notification triggering condition, and said notification triggering condition describes a condition for the user data repository sending a notification message; when receiving an update data request, if said update data request meets said notification triggering condition, send the notification message to a notification event subscriber.

Preferably, said user data repository is configured to establish said subscription to notification relationship by a following method: storing an original address of subscriber and subscription data, setting a data subscription status corresponding to the notification triggering condition as subscribed; said original address of subscriber comprising: an AS identity or address, or the AS application front end identity or address; said subscription data describing user subscription data corresponding to a subscription data change subscribed by subscription to notification event.

Compared with the prior technology, with the explicitly or implicitly establishing the subscription to notification relationship in the present invention, the problem of implementing the subscription to notification in the network system where the application logic processing and the data storage are separated is effectively solved, and based on the established subscription to notification relationship, the triggering of the expected notification message is achieved.

### BRIEF DESCRIPTION OF DRAWINGS

FIG. 1 is a schematic diagram of the UDC network system in the related art;

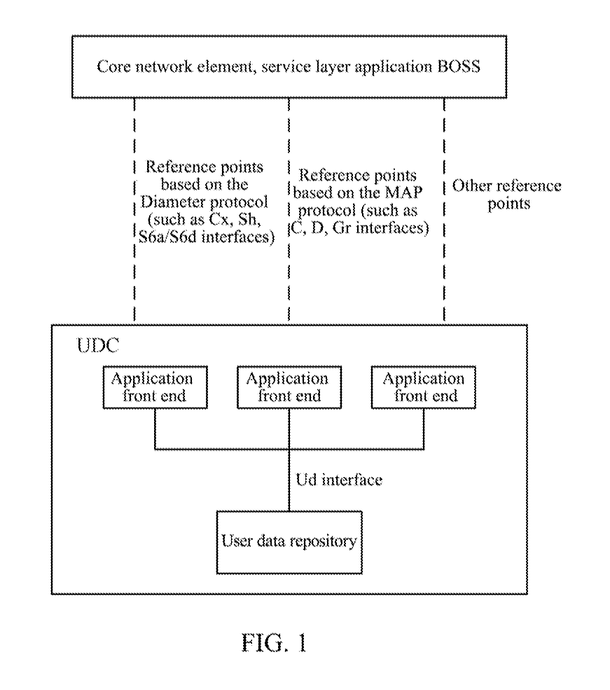

FIG. 2 is a schematic diagram of the explicitly establishing the subscription relationship based on the UDC network system in accordance with the present invention;

FIG. 3 is a flow chart of the first implementation method for triggering the notification about modification in the service subscription data in accordance with an embodiment of the present invention;

FIG. 4 is a flow chart of the second implementation method for triggering the notification about modification in the service subscription data in accordance with an embodiment of the present invention;

FIG. 5 is a flow chart of triggering a notification after deleting the user location information in accordance with an embodiment of the present invention;

FIG. 6 is a flow chart of sending a message request to another network domain based on the notification message triggering in accordance with an embodiment of the present invention;

FIG. 7 is a combination schematic diagram of an embodiment of the UDC network system in accordance with the present invention.

### PREFERRED EMBODIMENTS OF THE PRESENT INVENTION

The embodiments of the present invention will be illustrated in detail below in combination with the accompanying figures and embodiments, so as to fully understand how the present invention uses technical means to solve the technical problem and the process of achieving the technical effects and implement it.

The application front end of the UDC network in the prior technology processes the application logic which is not related to the data, and it is not responsible for storing the subscription data information, and it is not aware whether the specific data is subscribed to update the notification event; wherein, the user data repository stores the data, and it does not know whether the data changes or not, so that it cannot effectively trigger the notification message.

The main concept of achieving the subscription to notification based on the UDC network system in the present invention is: establishing the subscription to notification relationship in the user data repository at first, including explicitly establishing the subscription to notification relationship via a request message and implicitly pre-configuring and establishing the subscription to notification relationship by the local configuration policy; wherein, the subscription to notification relationship comprises the notification triggering condition and the notification type, as well as the subscription to notification data information on the subscription data generated by the explicit subscription to notification.

The notification triggering condition describes the condition for the user data repository sending a notification message, for example, for explicitly establishing the subscription to notification relationship, if the data is in the subscribed status and has changed, it is considered that it meets the notification triggering condition, and for implicitly establishing the subscription to notification relationship, if the event is in the subscribed status or the event is in the subscribed status and the data related to the event has changed, or the message corresponding to the event carries the notification flag indicating to send the notification message, it is considered that it meets the notification triggering condition. For example, the notification triggering condition corresponding to the subscription to notification on the subscription data comprises the data subscription status and the data change status, wherein the data change status describes the change status of the data subscribed by the subscription to notification event on the subscription data; the notification triggering condition corresponding to the location cancellation comprises the user location information deletion event or other possible event.

The notification type such as the indicator or the indication identity, corresponds to different notification triggering conditions, which is a one to multiple relationship, and it is used to indicate the service operation required to be performed by the application front end receiving the notification message.

When receiving the update data request message, the user data repository checks the notification triggering condition or directly judges whether it needs to send a notification, and if the condition is met or it needs to send a notification, trigger the notification process of the application front end supporting the application. The update data request comprises insertion, deletion or update of the user data and so on.

There are two methods for the user data repository checking the notification triggering condition: one method is that the user data repository directly compares whether the user subscription data changes or not, and completes checking the notification triggering condition according to the comparison result; the other method is that the application front end compares whether the user subscription data changes or not, and sends the comparison result to the user data repository via the interface message, and the user data repository completes checking the notification triggering condition according to the comparison result, wherein the interface message carries the indication flag indicating whether the user subscription data changes or not.

There are also two methods for the user data repository directly judging whether it needs to send a notification or not: one method is judging whether it needs to trigger a notification message or not according to the related information of the application front end, for example, if the application front end sending the request message supports the application type needed for processing the notification message, there is no need to trigger the notification message, otherwise, it is required to trigger the notification message; the other method is that the application front end directly notifies the user data repository whether it is required to send a notification message or not via the interface message, wherein the interface message carries the indication flag indicating whether it is required to trigger the notification message or not. The notification message in the notification process comprises the notification type and the notification data information, wherein the notification type is used to indicate the service operation required to be performed by the application front end receiving the notification message, such as the subscription to notification on the subscription data or location cancellation.

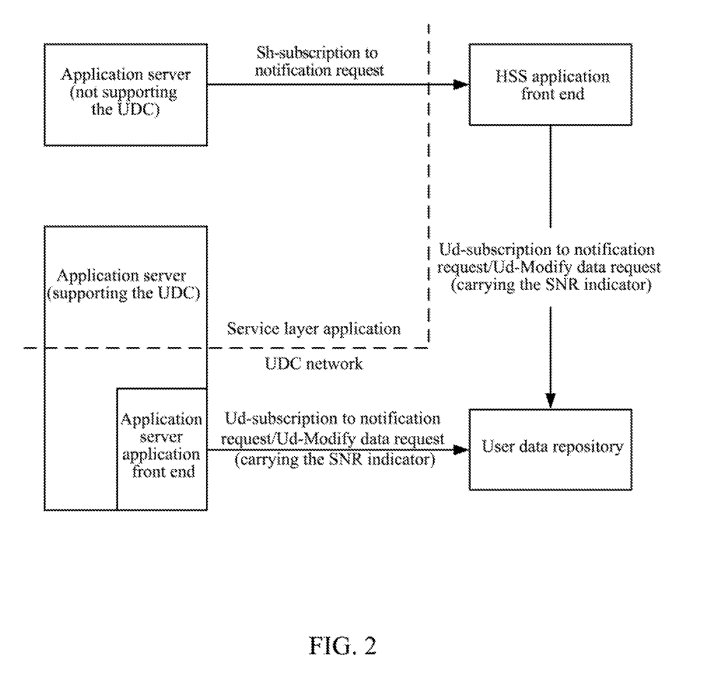

FIG. 2 is a schematic diagram of explicitly establishing the subscription to notification relationship based on the UDC network system in the present invention. As shown in FIG. 2, the explicit subscription relationship establishment mainly comprises the following technical features:

The user data repository pre-configures the notification triggering condition and the notification type. The notification triggering condition comprises the data subscription status and data change status that are pre-configured as data unsubscribed and data unchanged respectively. The notification type is configured as subscription to notification on the subscription data.

The application server (AS) supporting the user data convergence (UDC) comprises the AS front end that directly sends a subscription to notification request message or a modify data request message carrying the subscription to notification request (SNR) indicator to the user data repository via the Ud interface to make a request for establishing the subscription to notification relationship.

The AS which doesn't support the UDC sends the subscription to notification request message via the existing Sh interface of the HSS application front end. The HSS application front end sends the user data repository via the Ud interface a subscription to notification request message or a modify data request message carrying the SNR indicator to make a request for establishing the subscription to notification relationship.

After the user data repository receives the explicit subscription to notification request, it establishes the subscription to notification relationship, that is, it stores the subscription to notification data information on the subscription data, including the original address of the subscriber (the initial entity identity or address of data subscription, such as the AS identity or address, or the AS application front end identity or address) and the subscription data meanwhile, it sets the data subscription status corresponding to the notification triggering condition as subscribed. The subscription data describes the user subscription data corresponding to the subscription data subscribed by subscription to notification event, which can be one request data identity or request data domain name rather than the specific content of the user subscription data.

The main technical features of the implicit subscription relationship establishment based on the UDC network system in the present invention is that: the user data repository pre-configures and stores the notification triggering condition and the notification type according to the local configuration policy, and the notification triggering condition has a corresponding relationship with the notification type; the notification triggering condition can be a subscription event, or a subscription event and the change status of the data related to the subscription event, or the notification flag corresponding to the notification relationship and carried in the message in which the event is located, and these events are events involved in the notification process; for example, the notification triggering condition is the user location information deletion event, and the corresponding notification type is the location cancellation, and for example, the triggering condition is that there is a notification flag carried in the sent message of the user location information deletion event, and the notification type corresponding to the notification flag is the location cancellation, and for example, the notification triggering condition is the S6a single registration indication flag bit setting event, and the corresponding notification type is the MAP location cancellation.

The content of the notification triggering condition comprises the data subscription status as well as the data change status, or the subscription event, or the subscription event and the data change status; wherein, the data subscription status describes the subscription status of the data requested by a subscription to notification event on subscription data, including data subscribed or data unsubscribed; the data change status describes the change status of the data subscribed by the subscription to notification event on the subscription data, including the subscription data changed or the subscription data unchanged; the subscription event describes the event required to be triggered for the notification message, and it includes but not limited to the subscription data subscribed by subscription to notification event or the user location information deletion event.

It should be noted that the abovementioned notification type is location cancellation, and the corresponding subscription event might be any other event besides the user location information deletion event; the corresponding subscription event of the MAP location cancellation can be any event but the S6a single registration indication flag bit setting event.

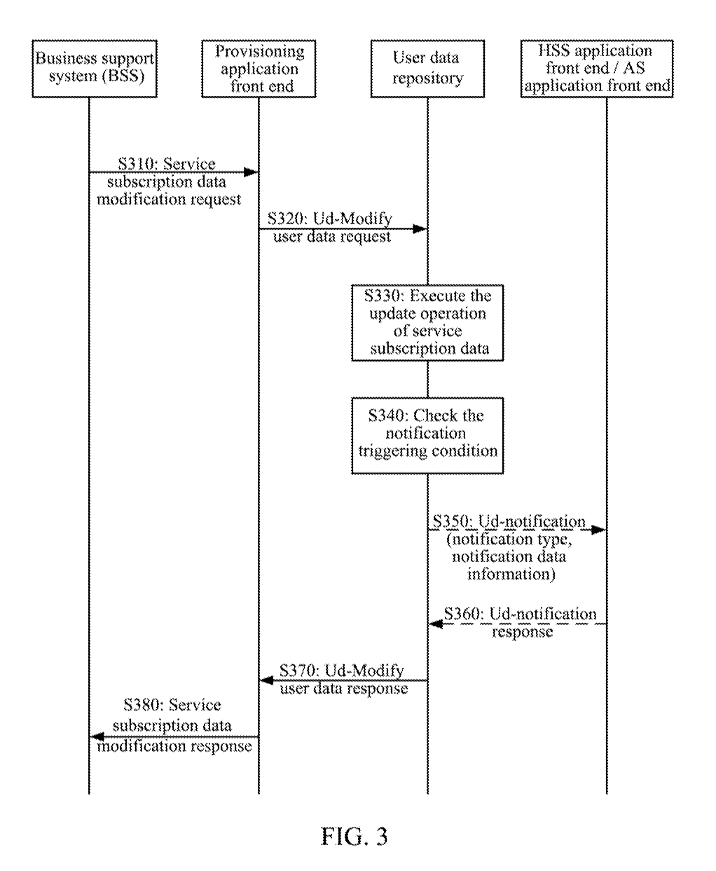

FIG. 3 is the flow chart of the first implementation method for triggering the notification about the modification in the service subscription data in accordance with an embodiment of the present invention. As shown in FIG. 3, the first implementation method for triggering the notification mainly comprises the following steps:
Step S310: the business support system (BSS) sends a service subscription data notification request message to the Provisioning (mainly providing support for the operators deploying services) application front end;
Step S320: the Provisioning application front end receives the service subscription data notification request message sent from the BSS and sends a modify user data request message to the user data repository via the uniform Ud interface between the Provisioning application front end and the user data repository, so as to modify the service subscription data stored in the user data repository.
Step S330: after the user data repository receives the modify user data request message sent from the Provisioning application front end, it performs the access control;
after carrying out effective authentication on the Provisioning application front end and carrying out effective authorization on the request data, the user data repository executes the update operation of service subscription data;
Step S340: the user data repository checks the notification triggering condition, that is, it judges whether the request data (here it is the service subscription data) changes or not, and check the subscription status of the request data;
judge whether the request data changes or not according to the change status of the request data; the change status of the request data can be acquired by the user data repository comparing the difference in the new and old data;
if the request data changes, and the change notification event of the request data has been subscribed, the user data repository triggers the notification process; otherwise, the notification process in steps S350 and S360 is not triggered;
Step S350: the user data repository sends a notification message to the notification event subscriber via the Ud interface, and the notification message carries the notification type and the notification data information;
the notification type is configured as subscription to notification on the subscription data, and it is used to indicate the application front end supporting the subscription to notification application to send the subscription to notification data to the subscriber;
the application front end supporting the subscription to notification application can be the HSS application front end, it sends the subscription to notification data to the AS by the notification message via the Sh interface; the application front end supporting the subscription to notification application can also be the AS application front end supporting the UDC network;
the notification data information comprises the original address of the subscriber (the initial entity identity or address of data subscription, such as the AS identity or address, or the AS application front end identity or address), the user identity (which uniquely identifies the user, such as the international mobile subscriber identity (IMSI)) and the subscription to notification data; wherein, the subscription to notification data is the latest changing content of the data subscribed in the subscription to notification event;
Step S360: the HSS application front end or the AS application front end returns a notification response message to the user data repository;
Step S370: the user data repository returns a modify user data response message to the Provisioning application front end;
Step S380: the Provisioning application front end returns the user data modification result to the BSS via the service subscription data modification response message.

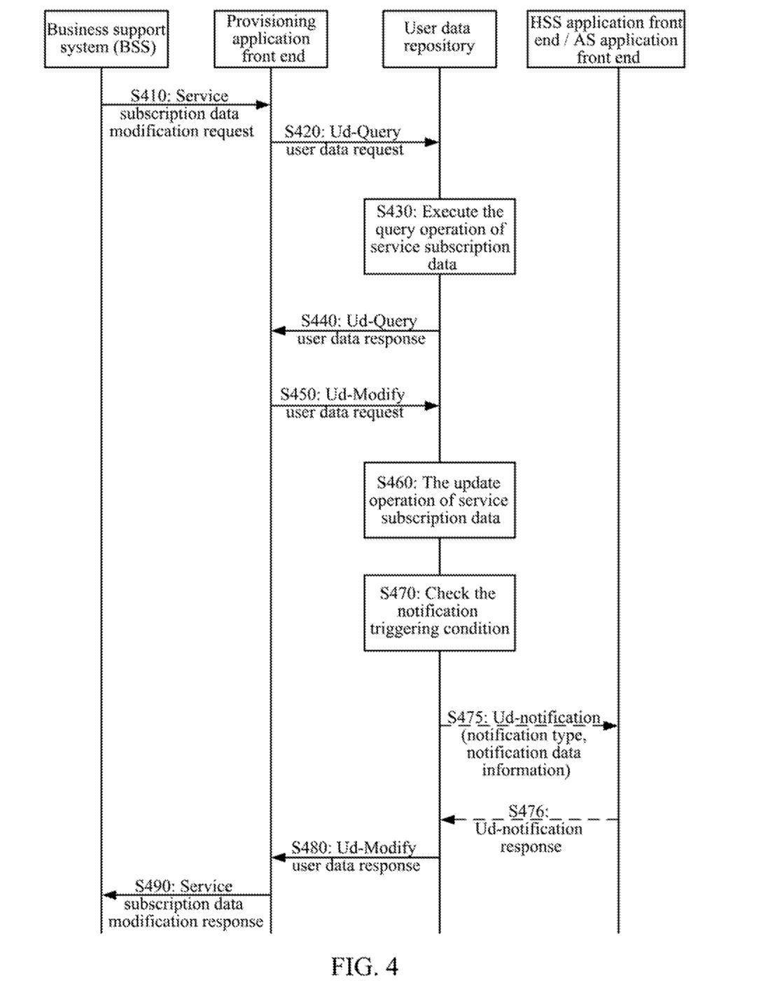

FIG. 4 is the flow chart of the second implementation method for triggering the notification about the modification in service subscription data in accordance with an embodiment of the present invention. As shown in FIG. 4, the method for implementing the notification triggering mainly comprises the following steps:
Step S410: the business support system (BSS) sends a service subscription data notification request message to the Provisioning application front end;
Step S420: the Provisioning application front end receives the service subscription data notification request message sent from the BSS and sends a query user data request message to the user data repository via the uniform Ud interface between the Provisioning application front end and the user data repository at first, so as to read the original service subscription data stored in the user data repository.
Step S430: after the user data repository receives the query user data request message, it performs the access control; after carrying out effective authentication on the Provisioning application front end and carrying out effective authorization on the request data, the user data repository executes the query operation of the service subscription data;
Step S440: the user data repository returns the query user data response message to the 1.5 Provisioning application front end, and sends the original service subscription data to the Provisioning application front end;
Step S450: after the Provisioning application front end receives the original service subscription data, it judges whether the service subscription data changes or not, that is, compares the difference in the new and old data;
if the service subscription data changes, the Provisioning application front end sets the data update flag, and carries the flag in the modify user data request message and sends it to the user data repository via the Ud interface;
Step S460: the user data repository receives the modify user data request message sent from the Provisioning application front end, and after judging that the Provisioning application front end has been authenticated and the request data has been authorized, the user data repository executes the update operation of the service subscription data;
Step S470: the user data repository checks the notification triggering condition, that is, it judges whether the request data (it is service subscription data here) changes or not, and checks the subscription status of the request data;
judge whether the request data changes or not according to the change status of the request data; the change status of the request data can be acquired by the user data repository according to the data update flag carried in the modify user data request message;
if the request data changes, and the change notification event of the request data has been subscribed, the user data repository triggers the notification process; otherwise, the notification process in steps S475 and S476 is not triggered;
Step S475: the user data repository sends a notification message to the notification event subscriber via the Ud interface, and the notification message carries the notification type and the notification data information;
the notification type is configured as subscription to notification on the subscription data, and it is used to indicate the application front end supporting the subscription to notification to send the subscription to notification data to the subscriber;
the application front end supporting the subscription to notification application can be the HSS application front end, and it sends the subscription to notification data to the AS by the notification message via the Sh interface; the application front end supporting the subscription to notification application can also be the AS application front end supporting the UDC network;
the notification data information comprises the original address of the subscriber (the initial entity identity or address of the data subscription, such as the AS identity or address, or the AS application front end identity or address), the user identity (which uniquely identifies the user, such as IMSI) and the subscription to notification data the subscription to notification data is the latest changing content of the data subscribed in the subscription to notification event;
Step S476: the HSS application front end or the AS application front end returns a notification response message to the user data repository;
Step S480: the user data repository returns a modify user data response message to the Provisioning application front end;
Step S490: the Provisioning application front end returns the result of the user data modification to the BSS by the service subscription data modification response message.

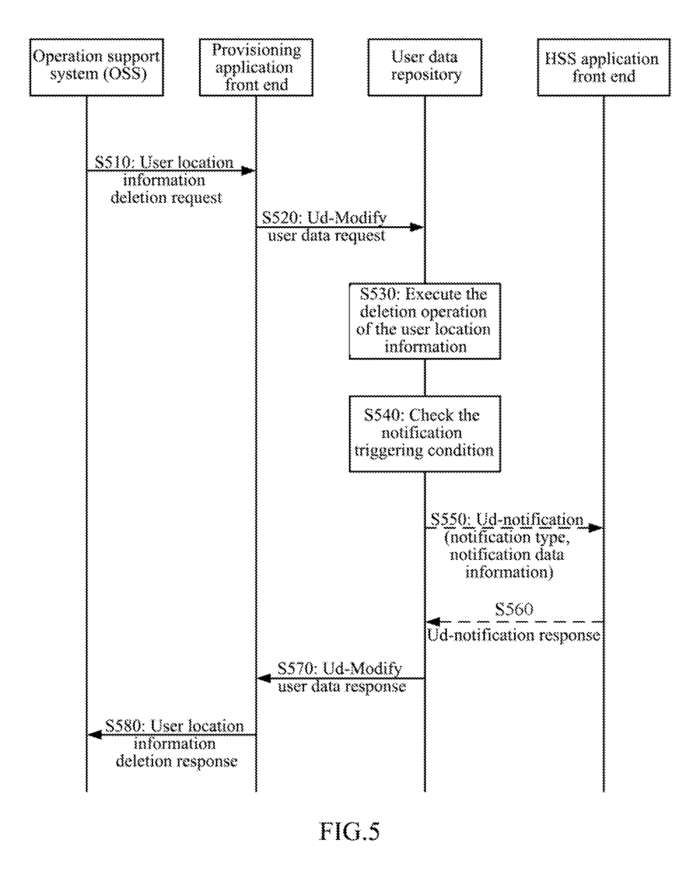

FIG. 5 is the flow chart of triggering a notification after deleting the user location information in accordance with an embodiment of the present invention. As shown in FIG. 5, the notification triggering process mainly comprises the following steps:
Step S510: the operation support system (OSS) sends a user location information deletion request message to the Provisioning application front end;
Step S520: the Provisioning application front end receives the user location information deletion request message sent from the OSS and sends a modify user data request message to the user data repository via the uniform Ud interface between the Provisioning application front end and the user data repository, so as to delete the original user location information stored in the user data repository.

In other embodiments, a notification flag is carried in the modify data request message, and the notification flag corresponds to the notification type of location cancellation, thus this notification flag is carried in the modify data request message to indicate the user data repository to trigger the notification process of the location information deletion.
Step S530: after the user data repository receives the modify user data request message sent from the Provisioning application front end, it performs the access control;
after carrying out effective authentication on the Provisioning application front end and carrying out effective authorization on the request data, the user data repository executes the deletion operation of the user location information;
Step S540: the user data repository checks the notification triggering condition, that is, it judges whether the user location information deletion event needs to trigger the notification process or not, and if yes, the user data repository triggers the notification process; otherwise, the notification process in steps S550 and S560 is not triggered;
Step S50, the user data repository sends a notification message to the HSS application front end via the Ud interface, and the notification message carries the notification type and the notification data information;
the notification type is configured as location cancellation, and it is used to indicate the HSS application front end to delete the user's registration information in the current network;
the notification data information comprises the information required by the HSS application front end to execute the abovementioned deletion operation, such as the user identity (which uniquely identifies the user, such as IMSI) and the current registered network entity identity or address of user;
Step S560: the HSS application front end returns a notification response message to the user data repository;
Step S570: the user data repository returns a modify user data response message to the Provisioning application front end:
Step S580: the Provisioning application front end returns the user location information deletion result to the OSS by the user location information deletion response message.

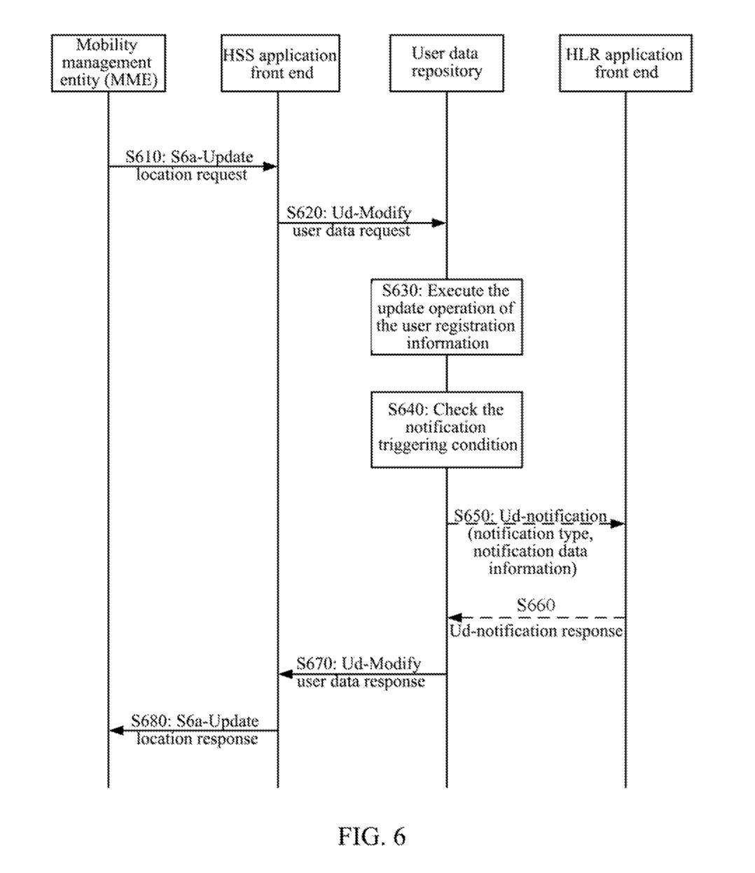

FIG. 6 is the flow chart of sending a message request to another network domain based on the notification message triggering in accordance with an embodiment of the present invention. As shown in FIG. 6, the process of message request mainly comprises the following steps:
Step S610: the mobile management entity (MME) sends an update location request message to the HSS application front end supporting the Diameter application via the S6a interface, and the update location request message carries the single registration indication flag bit;
Step S620: the HSS application front end receives the update location request message sent from the MME, it sends a modify user data request message to the user data repository via the uniform Ud interface between the HSS application front end and the user data repository, so as to store or update the user registration information in the user data repository.

In other embodiments, a notification flag is carried in the modify data request message, and the notification flag corresponds to the notification type of MAP-location cancellation, thus this notification flag carried in the modify data request message is used to indicate the user data repository to trigger the notification process of MAP-location cancellation.
Step S630: after the user data repository receives the modify user data request message sent from the HSS application front end, it performs the access control;
after carrying out effective authentication on the HSS application front end and carrying out effective authorization on the request data, the user data repository executes the update operation of the user registration information;
Step S640: the user data repository checks the notification triggering condition, that is, it judges whether the single registration indication flag bit event in the S6a—update location request message involved in the user registration information needs to trigger the notification process or not, and if yes, the user data repository triggers the notification process; otherwise, the notification process in steps S650 and S660 is not triggered.

In other embodiments, check whether the modify data request message carries the notification flag corresponding to the notification type of MAP-location cancellation or not, and if yes, the user data repository triggers the notification process of MAP-location cancellation;
Step 650, the user data repository sends a notification message to the HLR application front end supporting the MAP application via the Ud interface, and the notification message carries the notification type and the notification data information;
the notification type is configured as MAP-location cancellation, and it is used to indicate the HSS application front end to delete the user's registration information in the current GPRS network;
the notification data information comprises the information required by the HLR application front end to perform the abovementioned deletion operation, such as the user identity (which uniquely identifies the user, such as IMSI) and the user's registered network entity identity or address in the GPRS network in which the user is located;
Step S660: the HLR application front end returns a notification response message to the user data repository;
Step S670: the user data repository returns a modify user data response message to the HSS application front end;
Step S680: the HSS application front end returns the result of location update to the MME by the update location response message.

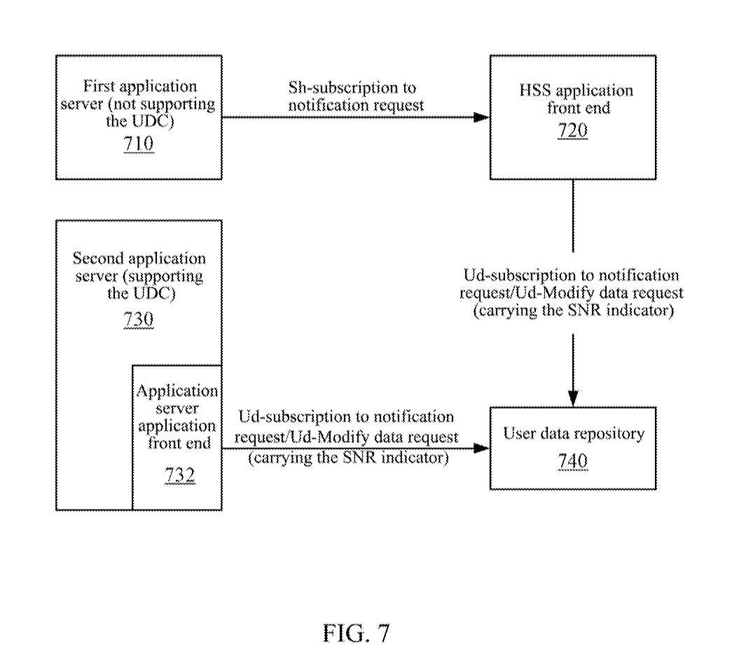

FIG. 7 is a combination schematic diagram of an embodiment of the UDC network system in accordance with the present invention. Refer to the corresponding content in the figures from FIG. 2 to FIG. 6 please, and the system embodiment shown in FIG. 7 mainly comprises the first application server 710, the HSS application front end 720, the second application server 730 and the user data repository 740, wherein:
the first application server 710 is an application server which doesn't support the UDC, and it is used to send the subscription to notification request message to the HSS application front end 720 via the Sh interface;
the HSS application front end 720 is used to: after receiving the subscription to notification request message sent from the first application server 710, send a subscription to notification request message or a modify data request message carrying the SNR indicator to the user data repository 740 via the Ud interface;
the second application server 730 is an application server supporting the UDC, and it is used to send the subscription to notification request message or the modify data request message carrying the SNR indicator by the internal application server front end 732 via the Ud interface to the user data repository;
the user data repository 740 is used to establish a subscription to notification relationship according to the subscription to notification request message or the modify data request message carrying the SNR indicator sent by the HSS application front end 720 or the second application server 730, or directly pre-establish the subscription to notification relationship; when receiving the update data request, if the update data request meets the notification triggering condition in the subscription to notification relationship, it sends a notification message to the notification event subscriber; the subscription to notification relationship comprises the notification triggering condition for the user data repository sending a notification message.

The operation of the user data repository 740 establishing the subscription to notification relationship comprises storing the original address of subscriber and the subscription data, and setting the data subscription status corresponding to the notification triggering condition as subscribed. The original address of subscriber comprises the AS identity or address, or the AS application front end identity or address. The subscription data is a request data identity or a request data domain name, and it describes the user subscription data corresponding to the subscription data subscribed by subscription to notification event.

The above description is only the preferred specific embodiments of the present invention rather than restriction of the protection scope of the present invention, and for those skilled in the field, variations or replacements can be thought of easily within the technical scope provided by the present invention, which should all be included in the protection scope of the present invention. Therefore, the protection scope of the present invention should belong to the protection scope of the claims of the present invention.

### INDUSTRIAL APPLICABILITY

Compared with the prior technology, with explicitly or implicitly establishing a subscription to notification relationship in the present invention, the problem about how to implement the subscription to notification in network systems where the application logic processing and data storage are separated is effectively solved, and the triggering of the expected notification message is achieved based on the established subscription to notification relationship.

What is claimed is:

1. A method for implementing subscription to notification, applied to a user data convergence network including a user data repository, the method comprising:
establishing a subscription to notification relationship in said user data repository; said subscription to notification relationship comprising a notification triggering condition which describes a condition of the user data repository sending a notification message;
when receiving an update data request, if said update data request meets the notification triggering condition or a notification is required to be sent, said user data repository sending the notification message to a notification event subscriber.

2. The method of claim 1, wherein the step of establishing said subscription to notification relationship in said user data repository is implemented by one of following methods:
after said user data repository receives a subscription to notification request message or a modify data request message carrying a subscription to notification request indicator, storing subscription to notification information; or
said user data repository pre-configuring and storing said subscription to notification information according to a local configuration policy.

3. The method of claim 2, wherein:
said subscription to notification request message or modify data request message is sent by an application server supporting user data convergence to the user data repository via an application server application front end, or sent by a home subscriber service application front end indicated by an application server which doesn't support the user data convergence to the user data repository.

4. The method of claim 1, wherein:
the step of establishing the subscription to notification relationship comprises: storing an original address of subscriber and subscription data, and setting a data subscription status corresponding to said notification triggering condition as subscribed;
wherein said original address of the subscriber comprises: an application server identity or address, or an application server application front end identity or address;
the subscription data describes that user subscription data corresponding to a subscription data subscribed by subscription to notification event is a request data identity or a request data domain name;
or,
the step of establishing the subscription to notification relationship comprises: the user data repository pre-configuring and storing the notification triggering condition and a notification type according to a local configuration policy, and the notification triggering condition having a corresponding relationship with the notification type.

5. The method of claim 1, wherein:
content of said notification triggering condition comprises a data subscription status and a data change status, or a subscription event, or the subscription event as well as the data change status;
said data subscription status describes a subscription status of data requested by a subscription to notification event on subscription data;
said data change status describes a change status of data subscribed by the subscription to notification event on the subscription data;
said subscription event describes an event required to be triggered for the notification message;
as long as any one of following conditions is met, the update data request meets the notification triggering condition:
data is in a subscribed status and changes;
the event is in the subscribed status;
the event is in the subscribed status and data related to the event changes;
a message corresponding to the event carries a notification flag indicating to send said notification message.

6. The method of claim 5, wherein:
after the step of receiving said update data request, said method also comprises:
judging whether user subscription data changes or not and checking whether the user subscription data is in the subscribed status or not, or judging whether an event corresponding to the update data request is in the subscribed status or not, or judging whether the event corresponding to the update data request is in the subscribed status and related user subscription data changes or not, or judging whether the event corresponding to said update data request carries the notification flag or not; and
determining whether the update data request meets said notification triggering condition or not according to a judgment result.

7. The method of claim 6, wherein:
the step of judging whether the user subscription data changes or not comprises:
the user data repository or an application front end comparing whether the user subscription data changes or not and acquiring a comparison result;
the step of determining whether the update data request meets the notification triggering condition or not according to the judgment result comprises: said user data repository determining whether the update data request meets the notification triggering condition or not according to the comparison result.

8. The method of claim 1, wherein:
after the step of receiving said update data request, said method also comprises:
judging whether the notification is required to be sent or not according to related information of an application front end, which comprises: the user data repository judging whether the application front end sending a request message supports an application type required to process the notification message;
or,
judging whether the notification is required to be sent or not according to an indication flag carried in the request message.

9. The method of claim 1, wherein:
said subscription to notification relationship comprises a notification type, and said notification type is to indicate a service operation required to be executed by the notification event subscriber;
said notification message carries said notification type and notification data information.

10. The method of claim 9, wherein:
when said notification type indicates the notification event subscriber to perform a subscription to notification on subscription data, said notification data information comprises an original address of subscriber, a user identity and subscription to notification data said subscription to notification data is the latest changing content of data subscribed by a subscription to notification event;
when said notification type indicates the notification event subscriber to execute location cancellation, said notification data information comprises the user identity as well as a current registered network entity identity or address of user.

11. The method of claim 10, wherein:
the step of the notification event subscriber executing the location cancellation comprises:
indicating a home subscriber service application front end to delete user's registration information in a current network, or indicating a home location register application front end to delete the user's registration information in a current general packet radio system network.

12. A user data convergence network system, comprising a first application server, a second application server, a home subscriber service application front end and a user data repository, wherein:
said first application server is configured to send a subscription to notification request message to the home subscriber service application front end;
said home subscriber service application front end is configured to: after receiving said subscription to notification request message sent from said first application server, send the subscription to notification request message or a modify data request message carrying a subscription to notification request indicator to the user data repository;
said second application server is configured to send the subscription to notification request message or the modify data request message carrying the subscription to notification request indicator to the user data repository via an application server application front end;
said user data repository is configured to: establish a subscription to notification relationship according to the subscription to notification request message or the modify data request message carrying the subscription to notification request indicator, or pre-establish said subscription to notification relationship; said subscription to notification relationship comprises a notification triggering condition, and said notification triggering condition describes a condition of the user data repository sending a notification message; when receiving an update data request, if said update data request meets said notification triggering condition, send the notification message to a notification event subscriber.

13. The system of claim 12, wherein:
said user data repository is configured to establish said subscription to notification relationship by a following method: storing an original address of subscriber and subscription data, setting a data subscription status corresponding to the notification triggering condition as subscribed; said original address of subscriber comprising: an application server identity or address, or an application server application front end identity or address; said subscription data describing user subscription data corresponding to a subscription data change subscribed by subscription to notification event.
